(19) United States
(12) Patent Application Publication
(10) Pub. No.: US 2014/0370455 A1
(43) Pub. Date: Dec. 18, 2014

(54) Passive Active Ligation System for Orthodontic Brackets

(71) Applicant: Timothy J. Allesee, St. Charles, IL (US)

(72) Inventor: Timothy J. Allesee, St. Charles, IL (US)

(21) Appl. No.: 14/473,648

(22) Filed: Aug. 29, 2014

Related U.S. Application Data
(63) Continuation-in-part of application No. 13/959,438, filed on Aug. 5, 2013.
(60) Provisional application No. 61/871,778, filed on Aug. 29, 2013.
(60) Provisional application No. 61/679,776, filed on Aug. 5, 2012.

(51) Int. Cl. A61C 7/30

(52) U.S. Cl. CPC A61C 7/303
USPC 433/13

(57) ABSTRACT

The invention provides a bracket having horizontally extending tabs that allow the arch wire to be ligated in either an active or passive manner using a ligation device such as an elastomeric band, metal ligature tie or the like. For an active ligation the ligation device is wrapped behind the tabs to press the arch wire into the bracket groove, and for a passive ligation the ligation device is wrapped in front of the behind two tabs that are diagonally oriented across the bracket groove, without pressing the arch wire into the bracket groove, or pressing the arch wire into the groove with a reduced force compared to the active ligation.

This application claims the benefit of U.S. Provisional Application No. 61/871,778 filed Aug. 29, 2013, and is a continuation-in-part of U.S. Ser. No. 13/959,438 filed Aug. 8, 2013, which claims the benefit of U.S. Provisional Application No. 61/679,776 filed Aug. 5, 2012.

### BACKGROUND OF THE INVENTION

Conventional orthodontic brackets with twin or single tie wings are generally considered to have “active” ligation. This means the ligation device (elastomeric tie or metal ligature tie) presses against the arch wire to hold it into the bracket slot or even “seat” the wire into the base of the bracket slot.

There are numerous types of brackets that are considered “passive” or “self ligating appliances” (SLA) in that the ligation device is a “door” or cap over the face of the bracket slot. This form of ligation does not actively seat the arch wire but rather allows it to be enclosed inside the four walls of the bracket slot. This type of “ligation” is generally believed to reduce the friction between the arch wire, ligation device and bracket slot and therefore facilitate sliding mechanics and expedite treatment.

The present inventor has recognized the need for an orthodontic system that could be selectively used is either the active or passive mode.

### SUMMARY OF THE INVENTION

The exemplary embodiment of the invention provides a bracket having a horizontally extending tab that allows the arch wire to be ligated in either an active or passive manner using a ligation device such as an elastomeric band, metal ligature tie or the like. For an active ligation the ligation device is wrapped behind the tab to press the arch wire into the bracket groove, and for a passive ligation the ligation device is wrapped in front of the tab, without pressing the arch wire into the bracket groove, or pressing the arch wire into the groove with a reduced force compared to the active ligation. According to a preferred embodiment, the bracket includes four tabs arranged in a rectangular pattern.

This new tie wing design shown in the illustration has an extension bar or “reverse L” design that allows the clinician to actively or passively ligate a conventional twin bracket without requiring ligation doors or caps. This design has the potential to dramatically reduce the complexity and cost of the bracket. This design has the potential to reduce the overall size and profile of the bracket and allow the operator to choose which type of ligation best suits the treatment requirements for the patient without requiring different bracket systems.

An alternate embodiment bracket provides four horizontal protrusions that are each located between a side slot and an end slot. The end slots would typically be located at the top and bottom of the bracket. An arch wire groove extends across the bracket between the end slots. The end slots are concave toward a direction away from the arch wire groove and the side slots are concave toward a direction parallel to the arch wire groove. The concave directions of the end slots and side slots allows for a clinician to passively ligate the arch wire using an elastomeric ring wrapped around the upper right protrusion and the lower left protrusion, or an elastomeric ring wrapped around the upper left protrusion and the lower right protrusion. For active ligation of the arch wire, the clinician wraps the elastomeric ring around the bracket beneath all four protrusions and on top of the arch wire.

Numerous other advantages and features of the invention will become readily apparent from the following detailed description of the invention and the embodiments thereof, from the claims, and from the accompanying drawings.

### BRIEF DESCRIPTION OF THE DRAWINGS

FIG. 1 is an elevation view of a tooth bracket before receiving an archwire or ligation element;

FIG. 2 is an elevation view of a tooth bracket having an archwire passing through the bracket slot and a ligation device engaging the bracket and archwire in an active ligation mode;

FIG. 3 is an elevation view of the bracket, archwire and ligation device in a passive ligation mode;

FIG. 4 is an elevation view the same as FIG. 1 but with exemplary dimensions shown;

FIG. 5 is a sectional view taken generally along line 5-5 of FIG. 4 with exemplary dimensions shown;

FIG. 6 is a perspective view of an alternate embodiment bracket according to the invention;

FIG. 7 is an elevation view of the bracket of FIG. 6;

FIG. 8 is a sectional view taken generally along line 8-8 of FIG. 7;

FIG. 9 is a bottom perspective view of the bracket of FIG. 6;

FIG. 10 is a sectional view taken generally along line 10-10 of FIG. 7;

FIG. 11 is a perspective view showing the bracket of FIG. 6 in an active ligation mode; and

FIG. 12 is a perspective view showing the bracket of FIG. 6 in a passive ligation mode.

### DETAILED DESCRIPTION

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

This application incorporates by reference U.S. Provisional Application No. 61/871,778 filed Aug. 29, 2013, U.S. Ser. No. 13/959,438 filed Aug. 5, 2013, and U.S. Provisional Application No. 61/679,776 filed Aug. 5, 2012, to the extent the applications are not inconsistent with the present disclosure.

FIG. 1 illustrates a tooth bracket 20 according to the present invention. While only one bracket is shown it is understood that a plurality of brackets are used in a patient's mouth. The application of tooth brackets and arch wires for orthodontic treatment is described for example in U.S. Pat. Nos. 5,820,370 and 5,474,448, herein incorporated by reference. The bracket 20 includes a vertical base 24 that is to be banded or adhered to a front face of a tooth as known, and four protuberances 26, extending out from the base 24 one at each corner of the base 24. Each protuberance includes an enlarged head 26a formed with a neck 26b that is formed with the base 24. Each head includes a horizontally extending tab 26c that extends outwardly of the protuberances. A horizontal slot 30 is formed between upper and lower protuberances.

FIG. 2 shows an arch wire 34 received into the slot 30. A ligation device 38 in the form of an elastomeric tie or band or metal ligature tie is wrapped around the necks 26b of the protuberances 26, behind the enlarged head 26a and behind the tabs 26c and over or in front of the arch wire 34, pressing the arch wire 34 into the slot 30 against the base 24. This is an active ligation engagement.

FIG. 3 illustrates the same configuration as FIG. 2 except the ligation device 38 is wrapped around the necks 26b of the protuberances behind the enlarged heads 26a but in front of the tabs 26c and over or in front of the arch wire 34. In this configuration the ligation device 38 does not press the arch wire 34 to the base, or presses the arch wire 34 into the groove 30 with a reduced force compared to the active ligation configuration of FIG. 2. FIG. 3 illustrates a passive ligation engagement.

It is apparent that switching from the configuration of FIG. 2 to FIG. 3 is readily accomplished based on the needs of the clinician.

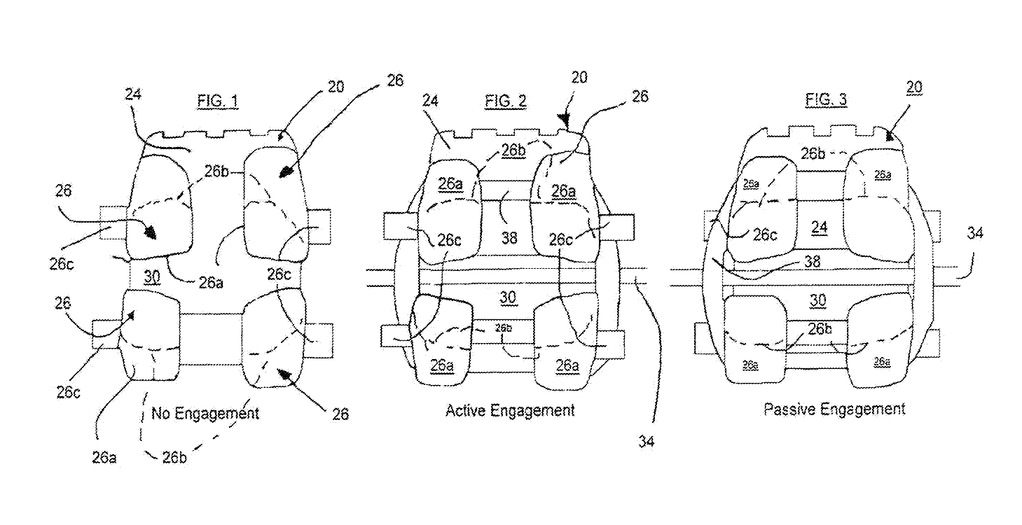

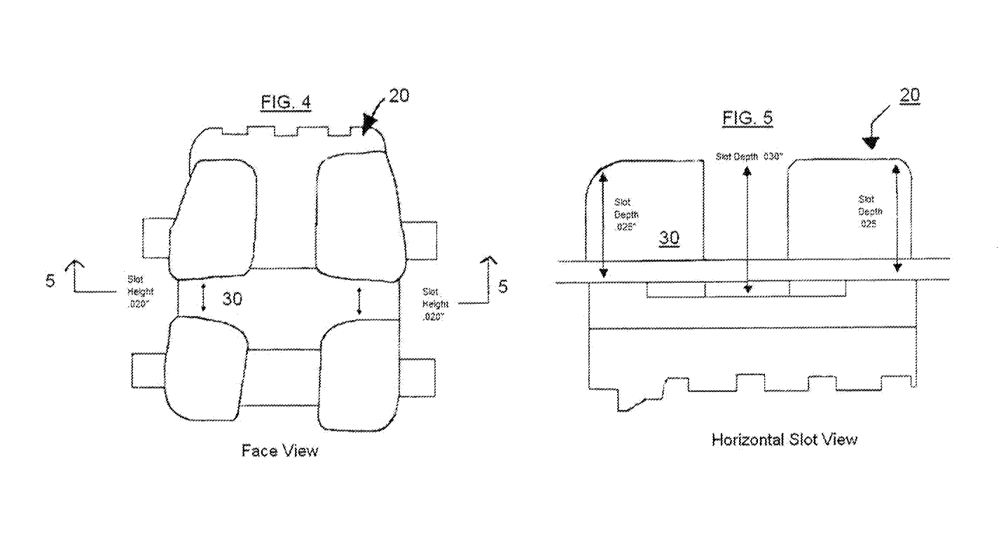

FIGS. 4 and 5 illustrate some exemplary dimensions for the bracket, but the invention is not limited to these dimensions.

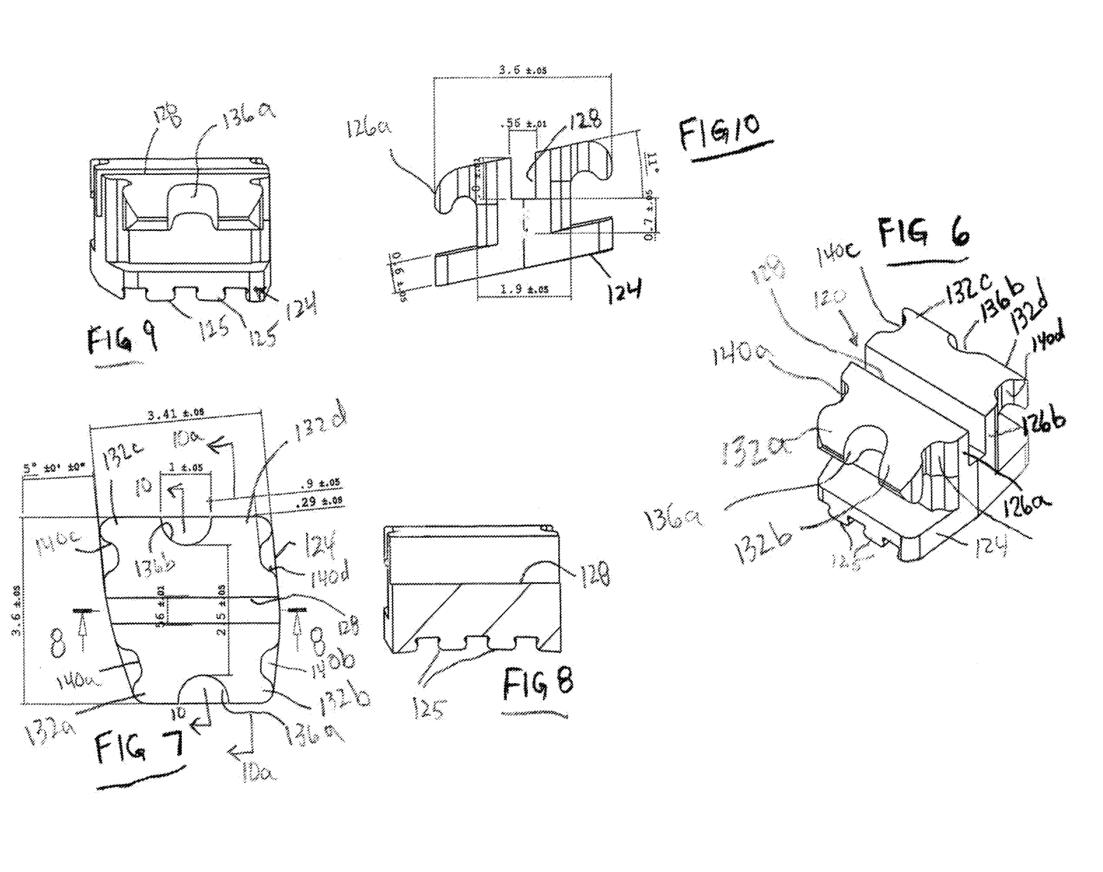

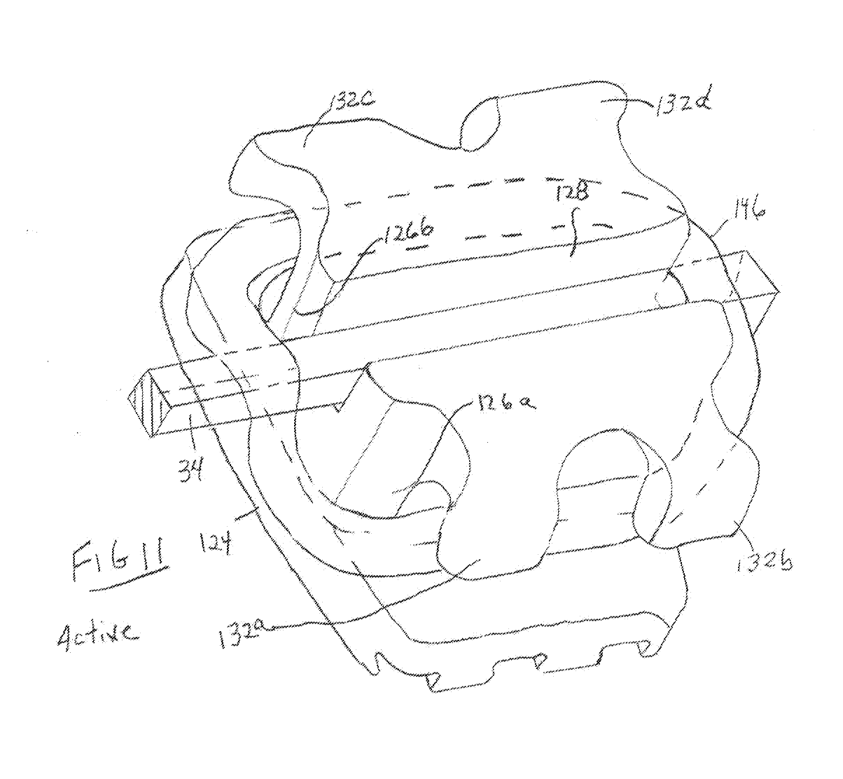

FIGS. 6-10 illustrate a tooth bracket 120 according to the present invention. While only one bracket is shown it is understood that a plurality of brackets are used in a patient's mouth. The application of tooth brackets and arch wires for orthodontic treatment is described for example in U.S. Pat. Nos. 5,820,370 and 5,474,448, herein incorporated by reference.

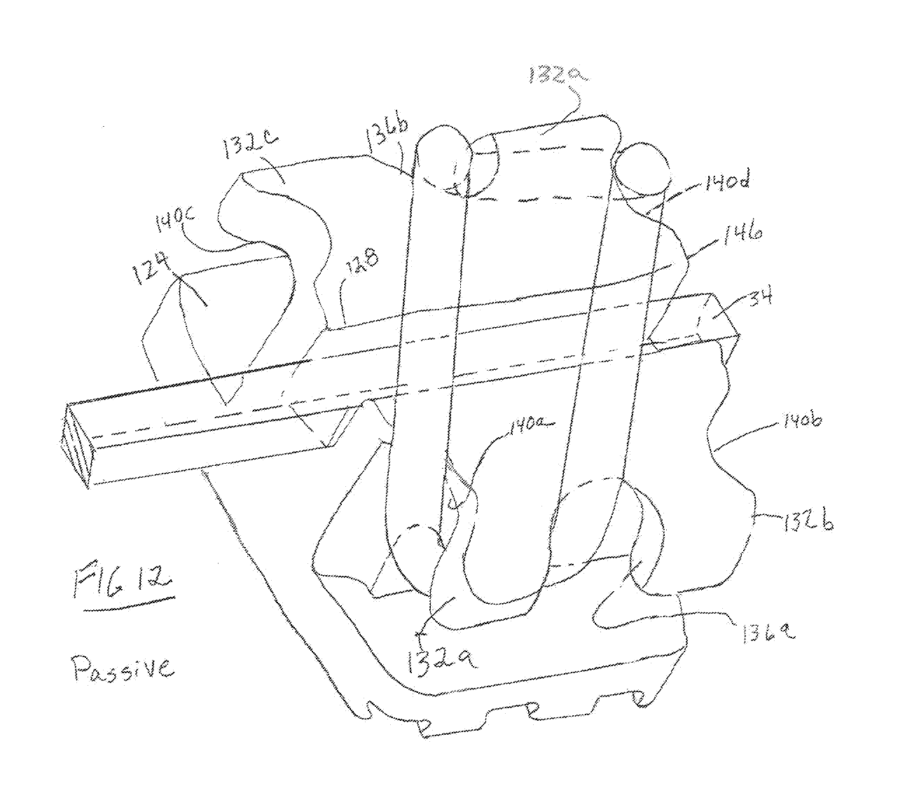

The bracket 120 can be composed of polycarbonate and includes a base 124 that is to be banded or adhered to a front face of a tooth as known. Extending substantially perpendicularly to the base 124 are two walls 126a, 126b that define an arch wire slot 128 therebetween. The base 124 includes dovetail ridges 125 that enhance securement to a tooth. Extending from the wall 126a are tabs in the form of hooks 132a, 132b; and extending from the wall 126b are tabs in the form of hooks 132c, 132d. The hooks 132a-132d are curved toward the base 124. An end slot 136a distinguishes or defines the hooks 132a, 132b and an end slot 136b distinguishes or defines the hooks 132c, 132d. Side slots 140a, 140b are located on outside sides of the hooks 132a, 132b and side slots 140c, 140d are located on outside sides of hooks 132c, 132d. The end and side slots are concave shaped and having a length that extends from a front face of the hooks in a direction toward the base. The hooks 132a, 132b have substantially the same cross section profile in planes taken substantially perpendicular to the axis of the length of the bracket groove such as shown in FIG. 10. The profile would be substantially the same taken through section lines 10a-10a of FIG. 7.

FIG. 11 shows an arch wire 34 received into the slot 128. A ligation device 146 in the form of an elastomeric tie or band or metal ligature tie is wrapped around the walls 126a, 126b behind (under) the hooks 132a-132d and in front of (over) the arch wire 34, pressing the arch wire 34 into the slot 128 against the base 124. This is an active ligation engagement.

FIG. 12 illustrates the same configuration as FIG. 11 except the ligation device 146 in the form of an elastomeric tie or band or metal ligature tie is wrapped around the hook 132a and the hook 132d over or in front of the hooks 132c, 132b, and over, or in front of, the arch wire 34. In this configuration, the ligation device 146 does not press the arch wire 34 to the base 124 or bottom of groove 128, or presses the arch wire 34 into the groove 128 with a reduced force compared to the active ligation configuration of FIG. 11. The side slots 140a, 140d and the end slots 136a, 136b are occupied by the ligation device 146. The slots 136a, 136b, 140a, 140d allow the secure cross tying of the ligation device or band on the bracket. FIG. 12 illustrates a passive ligation engagement.

Although the cross tying between the hooks 132a, 132d is shown in FIG. 12, the ligation device or band 146 could just as readily be cross tied around the hooks 132b, 132c using the slots 136a, 136b, 140b, 140c with substantially the same result. By cross tying the band 146 it is held securely in front of (over) the arch wire 34 in the passive ligation configuration.

It is apparent that switching from the configuration of FIG. 11 to FIG. 12 is readily accomplished based on the needs of the clinician.

FIGS. 7 and 10 illustrate some exemplary dimensions for the bracket, but the invention is not limited to these dimensions. Another exemplary set of dimensions include the bracket groove being .030 inches deep and .020 inches wide (height when the bracket is upright).

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A bracket having horizontally extending tabs that allow an arch wire to be ligated in either an active or passive manner using a ligation device; the bracket includes four tabs in a rectangular pattern and a bracket groove, and for an active ligation the ligation device is wrapped around the four tabs to press the arch wire into the bracket groove, and for a passive ligation the ligation device is wrapped around two first tabs which are opposite the bracket groove and not around two second tabs which are opposite the bracket groove, without pressing the arch wire into the bracket groove, or pressing the arch wire into the groove with a reduced force compared to the active ligation.

2. The bracket according to claim 1, wherein the two first tabs are arranged diagonal to the bracket groove.

3. The bracket according to claim 1, wherein each tab is distinguished by an end slot and a side slot, the end slot and side slot allowing the bracket to be used in a passive ligation by cross wrapping a ligation device between the two first tabs.

4. The bracket according to claim 3, wherein tabs on one side of the bracket groove have a common curved profile in a cross section taken in a plane perpendicular to a lengthwise axis of the bracket groove.

5. The bracket according to claim 4, wherein the bracket has a base for attachment to a tooth and the bracket groove and walls extending perpendicularly from the base and which define the bracket groove therebetween and two tabs extend perpendicularly from each of the walls, and tabs on the one side of the bracket are distinguished by an end slot that is concave shaped and having a length that extends from a front face of the tabs in a direction toward the base, and each of the tabs has a side slot that is concave shaped and having a length that extends the front face of the tabs toward the base.

6. A bracket having horizontally extending tabs that allow an arch wire to be ligated in either an active or passive manner using a ligation device:
the bracket includes a base a back surface for securement to a tooth and a front surface and having a bracket groove across the front surface for receiving an arch wire extending across the base and two first tabs extending from the front surface of the base, the two first tabs arranged on opposite sides of the bracket groove, and at least one second tab extending from the front surface of the base, and for an active ligation the ligation device is wrapped on a side of the two first tabs and the at least one second tab opposite the bracket groove to press the arch wire into the bracket groove, and for a passive ligation the ligation device is wrapped on a side of the two first tabs opposite the bracket groove and located on a side of the at least one second tab closest to the bracket groove.

7. The bracket according to claim 6, wherein the two first tabs are arranged diagonal to the bracket groove.

8. The bracket according to claim 6, wherein each tab is distinguished by an end slot and a side slot, the end slot and side slot allowing the bracket to be used in a passive ligation by cross wrapping a ligation device between the two first tabs.

9. The bracket according to claim 8, wherein tabs on one side of the bracket groove have a common curved profile in a cross section taken in a plane perpendicular to a lengthwise axis of the bracket groove.

10. The bracket according to claim 9, wherein the base has two walls extending perpendicularly from the base and which define the bracket groove therebetween and two tabs extending at least partly perpendicularly from each of the walls, and tabs on the one side of the bracket are distinguished by an end slot that is concave shaped and having a length that extends from a front face of the tabs in a direction toward the base, and each of the tabs has a side slot that is concave shaped and having a length that extends the front face of the tabs toward the base.
